(19) United States
(12) Patent Application Publication
(10) Pub. No.: US 2015/0002698 A1
(43) Pub. Date: Jan. 1, 2015

(54) INCLINATION ANGLE COMPENSATION SYSTEM AND METHOD FOR PICTURE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: QI-LONG YU, Shenzhen (CN)

(21) Appl. No.: 14/311,363

(22) Filed: Jun. 23, 2014

(30) Foreign Application Priority Data
Jun. 26, 2013 (CN) 201310259841X

(51) Int. Cl. H04N 5/232; H04N 1/21

(52) U.S. Cl. CPC H04N 5/23293; H04N 1/2129; H04N 5/23216
USPC 348/231.99

(57) ABSTRACT

Method for compensating for pictures captured by an inclined camera by re-orienting the angle of inclination of images includes steps of controlling the camera on an electronic apparatus to capture a picture, sensing an inclination angle formed between a long edge of the electronic apparatus and the horizontal, determining a first line which is parallel to a long edge of the electronic apparatus and a second line along the horizontal, controlling the first line and the second line to rotate until the first line and the second line are superimposed according to a user employing sliding or point touch, determining a sliding direction of the received user touch and controlling an object within the captured picture to rotate and saving the rotated picture.

### FIELD

The present disclosure relates to systems, and particularly to an inclination angle compensation system and a method for the inclination angle compensation for processing a picture.

### BACKGROUND

When a picture is captured by an electronic apparatus which is in an inclined state, the position of an object within the picture is also inclined, and it may not be convenient for the user to view or the user may require looking at a certain orientation of the image of the object.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic diagram of an embodiment of a running environment of an inclination angle compensation system.

FIG. 2 is a block diagram of an embodiment of the inclination angle compensation system of FIG. 1.

FIG. 3 shows a process for compensating for an inclination angle of a picture in a first embodiment.

FIGS. 4-5 show a process for compensating for the inclination angle of a picture in a second embodiment.

FIG. 6 shows a flowchart diagram of an embodiment of a method for compensating for the inclination angle of a picture implemented by the inclination angle compensation system of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

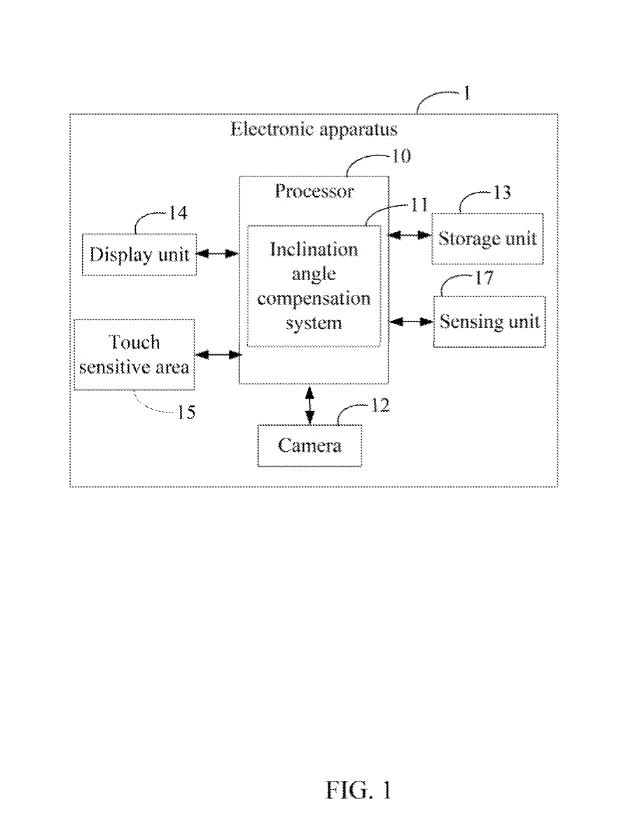

FIG. 1 is a schematic diagram of an embodiment of an inclination angle compensation system 11 (hereinafter “system 11”). The system 11 is applied in a portable electronic apparatus 1 (hereinafter “apparatus 1”). In one embodiment, the portable electronic apparatus 1 may be a cell phone, a digital photo frame, or the like.

The apparatus 1 includes a processor 10, a camera 12, a storage unit 13, a display unit 14, a sensing unit 17, and a touch sensitive area 15. The processor 10 controls the apparatus 1 to work. The camera 12 captures pictures. The sensing unit 17 senses an inclination angle formed between a long edge of the apparatus 1 and the horizon when the camera 12 captures one picture. The storage unit 13 stores pictures and an inclination angle associated with each picture. The display unit 14 displays information, such as pictures. The touch sensitive area 15 receives touch operations. In one embodiment, the display unit 14 cooperates with the touch sensitive area 15 to form a touch screen.

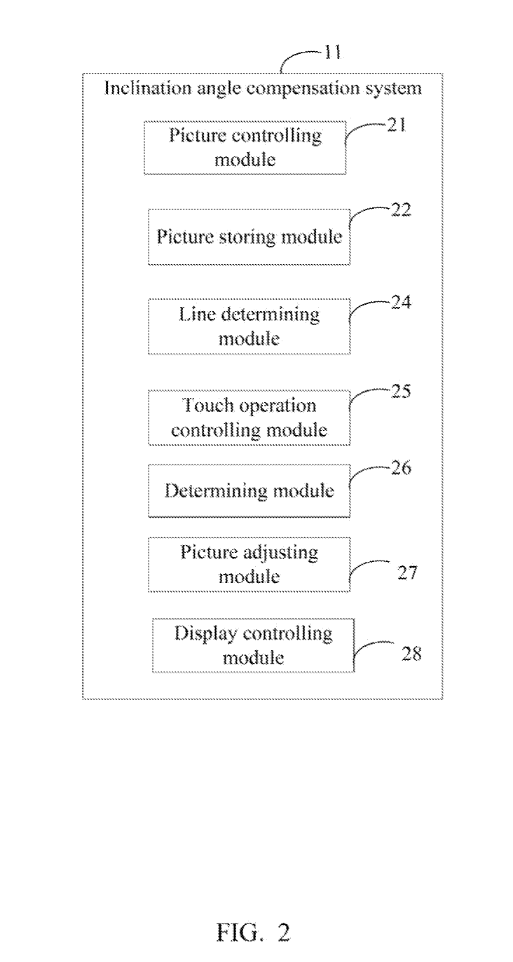

Referring to FIG. 2, the system 11 includes a picture controlling module 21, a picture storing module 22, a line determining module 24, a touch operation controlling module 25, a determining module 26, a picture adjusting module 27, and a display controlling module 28 altogether being a collection of software instructions executed by the processor 10.

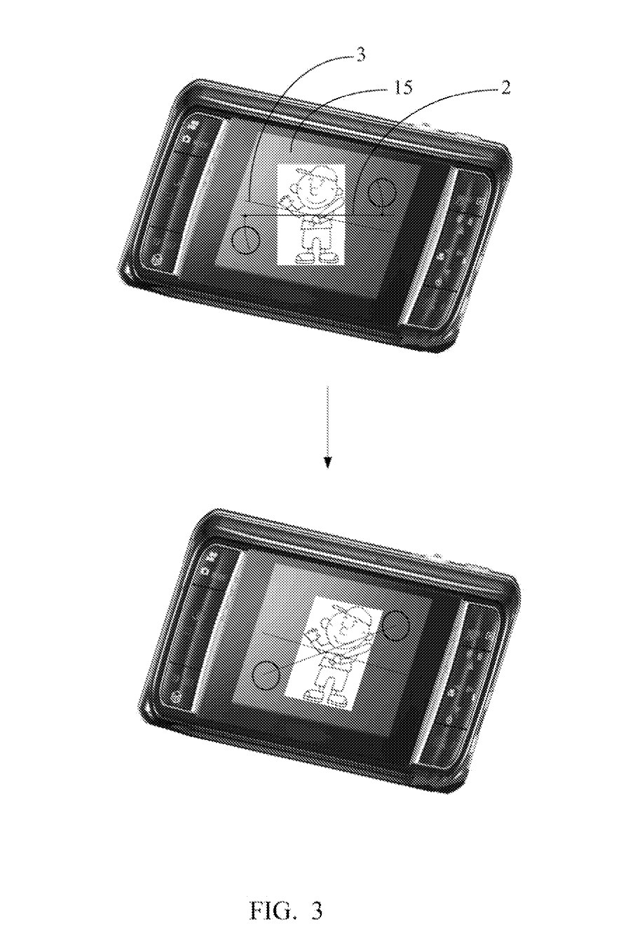

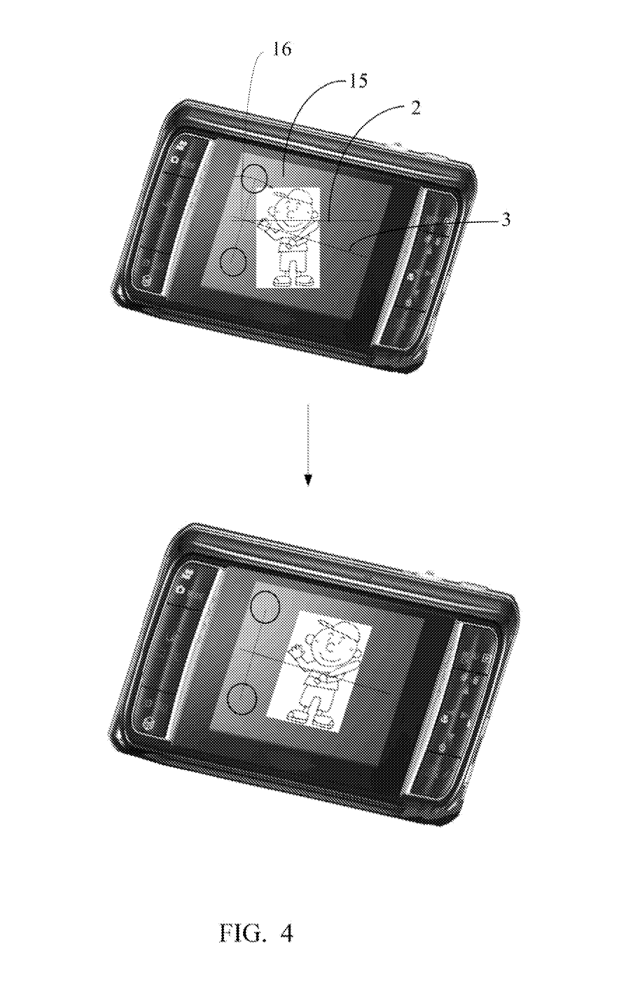

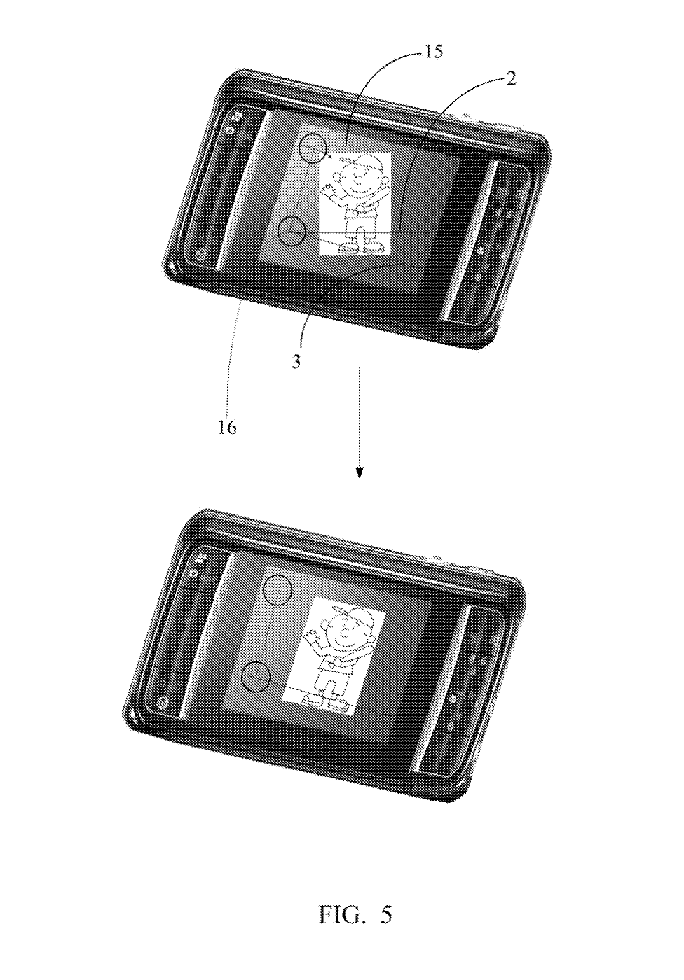

The picture controlling module 21 controls the camera 12 to capture a picture. The picture storing module 22 provisionally stores the captured picture and an inclination angle associated with the captured picture into the storage unit 13. The display controlling module 28 controls the display unit 14 to display the captured picture. The line determining module 24 determines the relativity to each other of a first line 3 (as shown in FIGS. 3-5) which is parallel to a long edge of the apparatus 1 and a second line 2 (as shown in FIGS. 3-5) which is parallel to the horizon. The display controlling module 28 controls the display unit 14 to display the first line 3 and the second line 2 on a predetermined display area. Generally, the first line 3 will intersect with the second line 2 to form an intersection when the apparatus 1 is in an inclined state. The touch operation controlling module 25 controls either the first line 3 or the second line 2 to rotate until the second line 2 and the first line 3 are superimposed in response to a touch operation from the touch sensitive area 15. In a first embodiment, touching operations can include a sliding operation, as shown in FIG. 3, in which the touch operation controlling module 25 sets up an intersection at the center of a circle as an axis around which the second line 2 can be rotated until the second line 2 is superimposed on the first line 3 in response to the sliding operation. In a second embodiment, the touching operations can include a point touch and a sliding operation, as shown in FIGS. 4-5, in which the touch operation controlling module 25 receives the point touch to determine a first point 16, and takes the first point 16 as the center of a circle around which the second line 2 is rotated until (according to the sliding operation) the second line 2 is rotated to superimposition on the first line 3 on the touch sensitive area 15. The determining module 26 determines a sliding direction of the touch operation. The picture adjusting module 27 controls an object within the picture to rotate with the sensed inclination angle along the determined sliding direction, thereby making a long edge of the picture parallel to the long edge of the apparatus 1. The picture storing module 22 stores the picture after rotation into the storage unit 13.

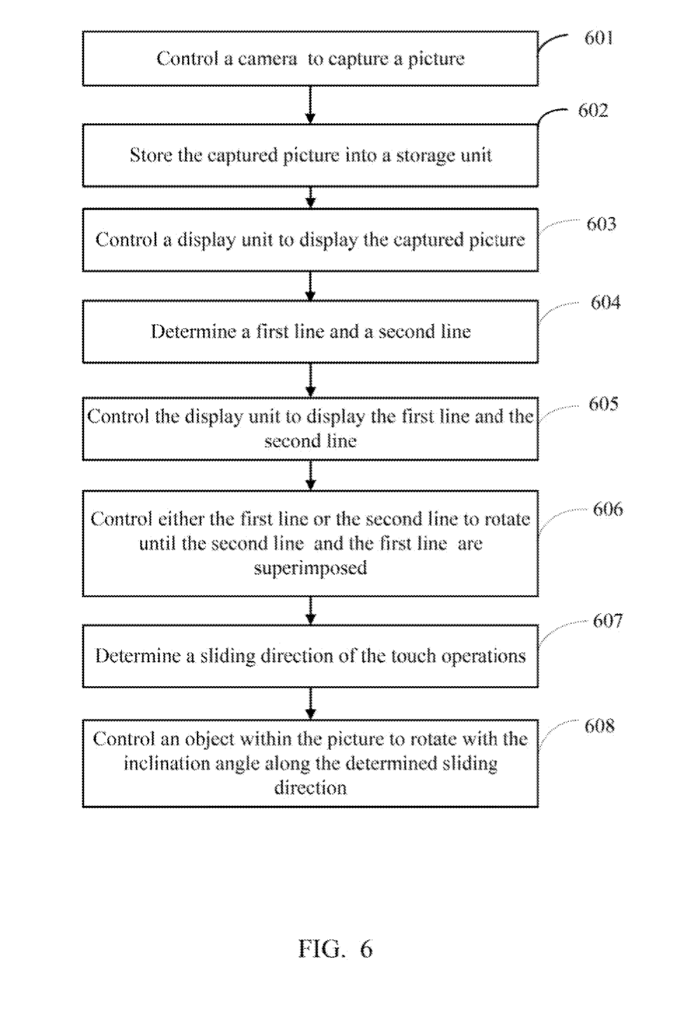

FIG. 6 shows a flowchart diagram of an embodiment of a method for compensating for the inclination angle of the picture implemented by the inclination angle compensation system of FIG. 2.

In 601, the picture controlling module 21 controls the camera 12 to capture a picture.

In 602, the picture storing module 22 provisionally stores the captured picture and the inclination angle associated with the captured picture into the storage unit 13.

In 603, the display controlling module 28 controls the display unit 14 to display the captured picture.

In 604, the line determining module 24 determines the relativity to each other of a first line 3 which is parallel to a long edge of the apparatus 1 and a second line 2 which is parallel to the horizon.

In 605, the display controlling module 28 controls the display unit 14 to display the first line 3 and the second line 2 on a predetermined display area.

In 606, the touch operation controlling module 25 controls either the first line 3 or the second line 2 to rotate until the second line 2 and the first line 3 are superimposed in response to user touch on the touch sensitive area 15.

In 607, the determining module 26 determines a sliding direction of the touch operations.

In 608, the picture adjusting module 27 controls an object within the picture to rotate with the sensed inclination angle along the determined sliding direction.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An inclination angle compensation system applied in an electronic apparatus, wherein the electronic apparatus comprises a camera, a sensing unit, a storage unit, a display unit and a touch sensitive area, the sensing unit is configured to sense an inclination angle formed between a long edge of the electronic apparatus and the horizon when the camera captures one picture, the touch sensitive area is configured to receive touch operations, the inclination angle compensation system comprising:
at least one processor; and
a plurality of modules to be executed by the at least one processor, wherein the plurality of modules comprise:
a picture controlling module configured to control the camera to capture a picture;
a picture storing module configured to provisionally store the captured picture into the storage unit;
a line determining module configured to determine a first line which is parallel to the long edge of the electronic apparatus and a second line which is parallel to the horizon;
a display controlling module configured to control the display unit to display the captured picture, the first line and the second line on a predetermined display area;
a touch operation controlling module configured to control either the first line or the second line to rotate until the second line and the first line are superimposed in response to a touch operation;
a determining module configured to determine a sliding direction of the received touch operation; and
a picture adjusting module configured to control an object within the captured picture to rotate with the sensed inclination angle along the determined sliding direction.

2. The inclination angle compensation system as described in claim 1, wherein the picture storing module is further configured to store the picture after rotation into the storage unit.

3. The inclination angle compensation system as described in claim 1, wherein the touch operation comprises a sliding operation, the touch operation controlling module is configured to set up an intersection at the center of a circle as an axis around which the second line is rotated until the second line is superimposed on the first line in response to the sliding operation.

4. The inclination angle compensation system as described in claim 1, wherein the touch operation comprises a point touch and a sliding operation, the touch operation controlling module is configured to receive the point touch to determine a first point, and take the first point as the center around which the second line is rotated according to the sliding operation until the second line is superimposed on the first line.

5. An inclination angle compensation method applied in an electronic apparatus, the inclination angle compensation method comprising:
controlling a camera to capture a picture;
sensing an inclination angle formed between a long edge of the electronic apparatus and the horizon when capturing one picture;
provisionally storing the captured picture;
determining a first line which is parallel to a long edge of the electronic apparatus and a second line which is parallel to the horizon;
controlling a display unit to display the captured picture, the first line and the second line on a predetermined display area;
controlling either the first line or the second line to rotate until the second line and the first line are superimposed in response to a touch operation;
determining a sliding direction of the touch operation; and
controlling an object within the captured picture to rotate with the sensed inclination angle along the determined sliding direction.

6. The inclination angle compensation method as described in claim 5, further comprising:
storing the picture after rotation.

7. The inclination angle compensation method as described in claim 5, wherein the touch operation comprises a sliding operation, the method further comprising:
setting up an intersection at the center of a circle as an axis around which the second line is rotated until the second line is superimposed on the first line in response to the sliding operation.

8. The inclination angle compensation method as described in claim 5, wherein the touch operation comprises a sliding operation and a point touch, the method further comprising:
receiving the point touch to determine a first point; and
taking the first point as the center around which the second line is rotated according to the sliding operation until the second line is superimposed on the first line.
